(19) United States
(12) Patent Application Publication
(10) Pub. No.: US 2025/0154390 A1
(43) Pub. Date: May 15, 2025

(54) ADHESIVE FORMULATIONS COMPRISING SILANES AND HYDROPHOBIZED FUMED SILICA

(71) Applicant: Evonik Operations GmbH, Essen (DE)

(72) Inventors: Jürgen Gerhard FRITZ, Grenzach-Wyhlen (DE); Thomas SCHLOSSER, Inzlingen (DE); Mario SCHOLZ, Gründau (DE); Daniela HUBER, Inzlingen (DE)

(73) Assignee: Evonik Operations GmbH, Essen (DE)

(21) Appl. No.: 18/722,063

(22) PCT Filed: Dec. 8, 2022
(86) PCT No.: PCT/EP2022/084887

§ 371 Date: Jun. 20, 2024

(30) Foreign Application Priority Data
Dec. 20, 2021 (EP) 21215904.0

(51) Int. Cl. C09J 11/06; C08K 5/5419; C08K 9/06; C09J 11/04; C09J 163/00

(52) U.S. Cl. CPC C09J 11/06; C09J 11/04; C09J 163/00; C08K 5/5419; C08K 9/06

(57) ABSTRACT

The present invention relates to liquid adhesive formulations comprising base polymer and alkyl silanes as well as hydrophobized fumed silica with low carbon content, i.e. in the range between 0.4 and 3.5 wt %. The specific combination of alkyl silane and hydrophobized fumed silica facilitates substantially increasing viscosity of the adhesive formulation. The present invention, further, relates to a process for the manufacture of such adhesive formulations as well as the use of combinations of alkyl silane and hydrophobized fumed silica with carbon content in the range between 0.4 and 3.5 wt % for modifying rheological properties of liquid adhesive formulations.

The present invention relates to liquid adhesive formulations comprising base polymer and alkyl silanes as well as hydrophobized fumed silica with low carbon content, i.e. carbon content in the range between 0.4 and 3.5 wt %. The specific combination of alkyl silane and hydrophobized fumed silica facilitates substantially increasing viscosity of the adhesive formulation. The present invention, further, relates to a process for the manufacture of such adhesive formulations as well as the use of combinations of alkyl silane and hydrophobized silica with carbon content in the range between 0.4 and 3.5 wt % for modifying rheological properties of liquid adhesive formulations.

Adhesive formulations are used in large numbers of applications in a broad range of industrial fields. In most cases such formulations are applied in liquid form or undergo liquefication at some point during their application. Accordingly, in order to improve their handling, rheological properties of liquid adhesive formulations need to be adjusted to the particular application process. In order to achieve this, rheology modifiers are added to such formulations. Different grades of silica are typically used for this purpose, in particular hydrophobized silica grades, i.e. silica that has been reacted or treated with a more hydrophobic compound in order to render the silica surface more hydrophobic.

Prior art methodology for adjusting rheological properties of liquid adhesive formulations via addition of silica, required use of hydrophobized silica with high carbon content. Using hydrophobized silica with low carbon content, in contrast, achieved only minor viscosity increase at lower shear rates. Unfortunately however, hydrophobized silica with high carbon content is relatively expensive and available only in fairly limited amounts. Accordingly, there is a need in the art for adhesive formulations facilitating a greater increase of viscosity by the addition of hydrophobized silica with low carbon content. Such formulations are provided by the present invention:

The present invention relates to

Liquid adhesive compositions comprising:
at least one base polymer,
at least one hydrophobized fumed silica, and
at least one alkyl silane;
wherein
   the base polymer is selected from:
   epoxy resins, unsaturated polyester resins, polyurethane, vinyl ester resins, acrylates, polyvinyl acetate, polyvinyl alcohol, polyvinyl ethers, ethylene-vinyl acetate, ethylene-acrylic acid copolymers, polyvinyl acetates, polystyrene, polyvinyl chloride, styrene-butadiene rubber, chloroprene rubber, nitrile rubber, butyl rubber, polysulphide, polyethylene, polypropylene, fluorinated hydrocarbons, polyamides, saturated polyesters and copolyesters, phenol-formaldehyde resins, cresol-/resorcinol-formaldehyde resins, urea-formaldehyde resins, melamine-formaldehyde resins, polyimides, polybenzimidazoles, polysulphones or mixtures thereof;
and wherein
   the hydrophobized fumed silica exhibits a carbon content in the range between 0.4 and 3.5 wt %;
and wherein
   the alkyl silane is selected from:
monomeric alkyl silanes of formula I:

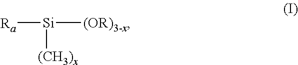

with
Rₐ=linear, branched or cyclic alkyl group with 1 to 18 carbon atoms,
x=0-2,
R=H₃C—(CH₂)_{y} with y=0-2;
or
linear oligomeric alkyl silanes of formula II:

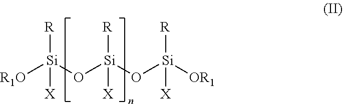

with
R=linear, branched or cyclic alkyl group with 1 to 18 carbon atoms,
R₁=H₃C—(CH₂)_{y} with y=0-2,
X=H₃C— or H₃C—(CH₂)_{y}O— with y=0-2,
n=0-20;
or
branched oligomeric alkyl silanes of formula III:

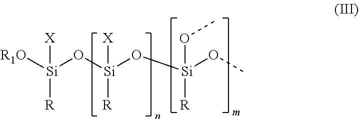

with
R=linear, branched or cyclic alkyl group with 1 to 18 carbon atoms,
R₁=H₃C—(CH₂)_{y} with y=0-2,
X=H₃C— or H₃C—(CH₂)_{y}O— with y=0-2,
n=0-20,
m=0-20;
or
cyclic oligomeric alkyl silanes of formula IV:

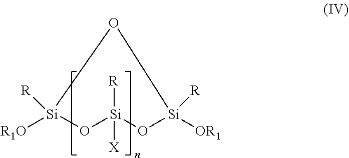

with
R=linear, branched or cyclic alkyl group with 1 to 18 carbon atoms,
R₁=H₃C—(CH₂)_{y} with y=0-2,
X=H₃C— or H₃C—(CH₂)_{y}O— with y=0-2,
n=0-20;
or mixtures of monomeric alkyl silanes of formula I and oligomeric linear, branched and/or cyclic alkyl silanes of formulae II, III and/or IV.

In the context of the present specification an adhesive, an adhesive composition or an adhesive formulation (all three terms are used here interchangeably) is defined as a non-metallic material able to join adherends by surface adhesion and internal strength. The prior art contains a large number of different adhesives, the great majority of which are based on organic compounds.

A distinction is made between physically setting adhesives and chemically curing adhesives. The physically setting adhesives are those in which the final adhesive substance, frequently a polymer, is used as it is and then a physical process causes the adhesive to solidify. Known accordingly, for example, are hotmelt adhesives, dispersion-based adhesives, wet adhesives containing organic solvents, and contact adhesives. A feature common to all of these types of adhesive is that first the adhesive is applied in a processable form and then solidification occurs as a result, for example, of evaporation of the solvent or of cooling. In the case of chemically curing adhesives, individual building blocks are applied and subsequently, by means of chemical reaction of the individual building blocks, a new product is formed which undergoes solidification. Among the reactive adhesives distinction is made between 2-component and 1-component systems. In the case of the 2-component systems, the adhesives are applied from separate constituents and solidify through a chemical reaction. In the case of 1-component adhesives, the adhesive cures in a chemical reaction, as a result of a change in the ambient conditions—for example, temperature increase, ingress of air, evaporation, moisture or atmospheric oxygen. The group of chemically curing adhesives includes, for example, cyanoacrylate adhesives, methyl methacrylate adhesives, anaerobically curing adhesives, radiation-curing adhesives, phenol-formaldehyde resin adhesives, silicones, silane-crosslinked polymer adhesives, polyimide adhesives, epoxy resin adhesives and polyurethane adhesives. An overview of the various adhesives can be found in Ullmann's Enzyklopädie der Chemie, 4th edition, volume 14, page 227 ff. (1997).

Liquid adhesive formulations, in the context of the present invention, are considered to be adhesive formulations that are applied in liquid form or undergo liquefication at some point during their application. Adhesives, in the context of the present invention, are products which, in accordance with their respective chemical composition and the physical state prevailing at the time of application to the adherends, allow wetting of the surfaces and, in their bonded joint, form the adhesive layer needed for the transmission of force between the adherends. In comparison to sealants, adhesives have higher tensile shear strengths and lower extension values; in other words, adhesives are hard to elastic, and sealants are elastic to plastic. Like sealants, adhesives comprise similar components in addition to the base polymer well known to people of skill in the art, such as, for example, solvents (ketones for example), water, fillers (chalk for example), thixotropic agents (pyrogenic silica for example), adhesion promoters (silanes for example), colour pastes (pigment-grade carbon black for example) and also further additives (e.g. catalysts, ageing inhibitors).

Fumed silica, in particular, have been known to act as very effective thixotropic agents (cf. e.g. Winnacker-Küchler, Chemische Technologie, volume 3 (1983), 4th edition, page 77 and Ullmann's Enzyklopädie der technichen Chemie, 4th edition (1982), volume 21, page 462 ff). Fumed silica is widely used, for example, in adhesives based on epoxy resins (Degussa Pigments brochure series (2001) Nos. 27 and 54). Application of fumed silica as rheology modifier in adhesives formulation is facilitated sometimes, in cases where silica handling is difficult, by using hydrophobized fumed silica, i.e. fumed silica that has been reacted or treated with an organic compound (usually an organosilicon compound such as dimethyldichlorosilane, trimethoxyoctylsilane, polydimethylsiloxaneis or hexamethyldisilazane) to replace at least a portion of the silanol groups on the surface of the fumed silica with less hydrophilic groups.

In the context of the present specification hydrophobized fumed silica is defined as fumed silica that has been reacted or treated with an organic compound (usually an organosilicon compound such as dimethyldichlorosilane, trimethoxyoctylsilane, polydimethylsiloxane or hexamethyldisilazane or Octamethylcyclotetrasiloxan) to replace at least a portion of the silanol groups on the surface of the fumed silica with less hydrophilic groups. Combinations of fumed silicas can also be used in preparing the adhesive composition. Methods of preparing hydrophobic fumed silicas are well-known in the art and include, for example, the methods described in US2010200803A1.

The degree of hydrophobization of a specific charge of hydrophobized fumed silica can be evaluated from its carbon content, high carbon content signifying a high degree of hydrophobization and low carbon content signifying a low degree of hydrophobization.

In the context of the present invention the carbon content of a charge of hydrophobized fumed silica is understood to be the carbon content as measured in accordance with DIN EN ISO 3262-20, as follows: A sample is burned in a crucible, if necessary covered with a suitable catalyst, in an induction furnace in a stream of oxygen. Sulfur compounds, halogens and water vapor are removed from the combustion products which are then then passed over a platinum catalyst (to convert carbon monoxide into carbon dioxide), the carbon dioxide concentration is then measured with an infrared cell detector.

The hydrophobized fumed silica of the liquid adhesive compositions of the present invention exhibit a carbon content in the range between 0.4 and 3.5 wt %.

In a preferred embodiment the at least one hydrophobized fumed silica in the liquid adhesive composition according to the present invention exhibits a carbon content in the range between 0.4 and 3.0 wt %.

In a particularly preferred embodiment the at least one hydrophobized fumed silica in the liquid adhesive composition according to the present invention exhibits a carbon content in the range between 0.4 and 2.0 wt %.

In another particularly preferred embodiment the at least one hydrophobized fumed silica in the liquid adhesive composition according to the present invention exhibits a carbon content in the range between 1.0 and 3.0 wt %.

In another particularly preferred embodiment the at least one hydrophobized fumed silica in the liquid adhesive composition according to the present invention is selected from AEROSIL® R 974 (carbon content=0.9-1.5 wt %), AEROSIL® R 106 (carbon content=1.4-3.0 wt %) or mixtures thereof.

Hydrophobized fumed silica is typically added to adhesive compositions in a mass fraction between 1 and 30 wt % of the total mass of the respective composition. Accordingly, in a preferred embodiment of the present invention the total mass of the at least one hydrophobized fumed silica according to the present invention is in the range between 1 and 30 wt % of the total mass of the liquid adhesive composition. In a particularly preferred embodiment of the present invention the total mass of the at least one hydrophobized fumed silica according to the present invention is in the range between 2 and 10 wt % of the total mass of the liquid adhesive composition.

A number of base polymers suitable for the adhesive formulations of the present invention are known to people of skill in the art.

The adhesive compositions of the present invention comprise as base polymer one of the following: Epoxy resins, unsaturated polyester resins, polyurethane, vinyl ester resins, acrylates, polyvinyl acetate, polyvinyl alcohol, polyvinyl ethers, ethylene-vinyl acetate, ethylene-acrylic acid copolymers, polyvinyl acetates, polystyrene, polyvinyl chloride, styrene-butadiene rubber, chloroprene rubber, nitrile rubber, butyl rubber, polysulphide, polyethylene, polypropylene, fluorinated hydrocarbons, polyamides, saturated polyesters and copolyesters, phenol-formaldehyde resins, cresol-/resorcinol-formaldehyde resins, urea-formaldehyde resins, melamine-formaldehyde resins, polyimides, polybenzimidazoles, polysulphones or mixtures thereof.

In a particularly preferred embodiment of the present invention the base polymer is an epoxy resin.

In a most preferred embodiment of the present invention the base polymer is Epikote™ Resin 828.

Epoxy resins are used preferably as base polymers for adhesives. Epoxy resins are prepared for example by condensing 2,2-bis(4-hydroxyphenyl)propane and epichlorohydrin in a basic medium. Depending on the equivalents of both reactants that are employed, the products are glycidyl ethers with different molar masses. In recent years, epoxy resins from bisphenol F, novolak epoxy resins, and cycloaliphatic and heterocyclic epoxy resins have also acquired importance.

Since epoxy resins on their own are poor film formers, molecular enlargement is required by means of suitable crosslinking agents. Examples of crosslinking agents used for epoxy resins include polyamines, polyaminoamides, carboxylic anhydrides and dicyandiamides. Among the amine curing agents a distinction is made between aliphatic, cycloaliphatic, aromatic and araliphatic polyamines. Curing takes place without elimination of reaction products. It generally involves the addition of a reactive hydrogen atom to the epoxide group, with formation of a hydroxyl group.

Unsaturated polyester resins are used preferably as base polymers for adhesives. They are obtained by polycondensation of unsaturated and saturated dicarboxylic or polycarboxylic acids with alcohols. Given a suitable reaction regime, the double bonds remain in the acid and/or alcohol and permit polymerization reactions with unsaturated monomers, styrene for example. Unsaturated dicarboxylic acids used with preference are as follows: maleic anhydride, maleic acid, fumaric acid.

Saturated dicarboxylic acids used with preference are as follows: ortho-phthalic acid and ortho-phthalic anhydride, isophthalic acid, terephthalic acid, tetrahydrophthalic acid, hexahydrophthalic acid, adipic acid, azelaic acid, sebacic acid, hexachloroendo-methylenetetrahydrophthalic acid, tetrabromophthalic acid.

Glycols used with preference are as follows: propylene 1,2-glycol, ethylene glycol, butylene glycol, neopentyl glycol, 2,2,4-trimethylpentane-1,3-diol, dibromoneopentyl glycol, diethylene glycol, triethylene glycol, dipropylene glycol, pentaerythritol diallyl ether, dicyclopentadiene.

Monomers for the crosslinking used with preference are as follows: styrene, alpha-methylstyrene, meta- and para-methylstyrene, methyl methacrylate, diallyl phthalate, triallyl cyanurate.

This listing does not exhaust the number of possible starting materials. The skilled person will be able, depending on the raw material situation, to use other compounds as well. Furthermore, the addition of dicyclopentadiene is customary, and the reactivity of the resins is modified as a result. The “unsaturated polyester resins” produced can be used as such or in dilution with reactive monomers. Reactive monomers are styrene, stilbene, esters of acrylic acid, esters of methacrylic acid, diallyl phthalate, and other unsaturated compounds, provided that they have a sufficiently low viscosity and adequate miscibility with the unsaturated polyester resin.

Polyurethane resins are used preferably as base polymers for adhesives. The polyurethanes are derived from isocyanic acid. As an extremely reactive compound, it undergoes addition very readily with compounds which possess an active hydrogen atom. In the course of this reaction the double bond between the nitrogen and the carbon is cleaved, the active hydrogen becoming attached to the nitrogen and the oxygen-combining radical to the carbon, to form a urethane group. In order to obtain higher molecular mass crosslinked polyurethanes of the kind needed for adhesive and sealant layers, it is necessary to provide reaction partners which are starting products having at least two functional groups, such as di- or triisocyanates, for example diphenylmethane 4,4-diisocyanate (MDI) with polymeric fractions, or reaction product of tolylene diisocyanate (TDI) and polyols, and polyhydric alcohols (diols or polyols, compounds having two or more hydroxyl functions in the molecule). Alcohols of this kind may also be present, for example, in the form of saturated polyesters, which are prepared with an excess of polyalcohols.

Two-component reactive adhesives are composed of a low molecular mass polyisocyanate and a likewise relatively low molecular mass polyol, e.g. polyetherpolyol or polyesterpolyol as for example polyalkylene polyadipate. Following the combining of the two components, urethane groups are formed in the adhesive or in the adhesive layer.

One-component reactive adhesives are composed of a relatively high molecular mass polyurethane, which sets by reacting with atmospheric moisture. In principle the situation here as well is one of two inter-reacting chemical components, but only one physical component is supplied for adhesive processing. Since, on reaction with moisture, the simple low molecular mass polyisocyanates form relatively hard and brittle adhesive layers with low strength values, the one-component systems start from precrosslinked polymers, known as prepolymers. These compounds are prepared from relatively high molecular mass polyols with a stoichiometric excess of isocyanate. In this way, the compounds present already possess urethane bonds, but in addition possess reactive isocyanate groups as well, which are amenable to the reaction with moisture. The reaction with water proceeds with the formation of a urea bond. The primary amines formed in the course of the decomposition reaction react immediately with further isocyanate groups to form polyureas. In the case of the one-component systems, therefore, the fully cured polymer contains not only urethane compounds but also urea compounds.

Solvent-borne polyurethane adhesives are available as physically setting systems and as chemically reacting systems. In the case of the physically setting systems the polymer takes the form of a high molecular mass hydroxyl polyurethane, the solvent used being, for example, methyl ethyl ketone. The chemically reacting systems include additionally hydroxyl polyurethane and a further polyisocyanate as crosslinker and as a second component.

Dispersion-based adhesives comprise a high molecular mass polyurethane in dispersion in water.

In the case of thermally activable polyurethane adhesives the isocyanate component is in “capped” or “blocked” form in a compound which eliminates the isocyanate component only at a relatively high temperature.

Reactive polyurethane hotmelt adhesives are prepared by using relatively high molecular mass, crystallizing and meltable diol and isocyanate components. These components are applied as hotmelt adhesives at temperatures from around 70° C. to 120° C. to the adherends. After cooling, the bond acquires a sufficient initial strength, which allows rapid further processing. Subsequently, as a result of additional moisture exposure of the reactive isocyanate groups still present, crosslinking then takes place via urea bonds, to form the adhesive layer polymer.

Vinyl ester resins are used preferably as base polymers for adhesives. On the chemical side, vinyl ester resins possess a certain relationship to the UP resins, in particular as far as curing reaction, processing technology and field of use are concerned. These resins are polyadducts of liquid epoxy resins and acrylic acid. As a result of reduction of ester groups in the molecule chain, these resins have better hydrolysis resistance in tandem with effective elasticity and impact toughness. Monomers used for crosslinking are the same as for the unsaturated polyester resins, styrene in particular.

Acrylates are used preferably as base polymers for adhesives. The collective term “acrylate-based adhesives” encompasses all of the reactive adhesives whose curing takes place via the carbon-carbon double bond of the acrylic group.

Particular significance in adhesive formulations has been acquired by the methacrylic esters and the alpha-cyanoacrylic esters. The curing of the acrylate adhesives is accomplished by addition polymerization, in the course of which an initiator triggers a chain reaction leading to a continuous curing of adhesive. The polymerization of the “acrylate” adhesives can be initiated by means of free radicals or alternatively, in the case of the alpha-cyanoacrylates, by means of anions. In accordance with the polymerization mechanism that is utilized for curing, the acrylate adhesives are also subdivided into the following groups:
anionically curing adhesives: alpha-cyanoacrylate 1-component adhesives, free-radically curing adhesives: anaerobic 1-component adhesives, free-radically curing adhesives: 2-component adhesives

In the case of the sealants based on polyacrylic esters or acrylic ester copolymers and polymethacrylic esters a distinction is made between solvent-borne and aqueous systems. Polyacrylate sealants cure physically by evaporation of the solvent or of the dispersion water.

Polyvinyl acetates are used preferably as base polymers for adhesives. Polyvinyl acetate is the product of polymerization of vinyl acetate. Owing to the strongly polar acetate group present in the molecule, polyvinyl acetate possesses very good adhesion properties to many adhered surfaces. Use is predominantly as a dispersion-based adhesive with a solids content of approximately 50% to 60%, in some cases also based on vinyl acetate copolymers (with vinyl chloride, for example).

Polyvinyl alcohols are used preferably as base polymers for adhesives.

Polyvinyl alcohol comes about as a product of hydrolysis of polyvinyl acetate and other similar polyesters. Depending on molecular weight, the polyvinyl alcohol takes the form of a liquid having a more or less high viscosity. It is used, for example, for bonding cellulosic materials, such as paper, cardboard, wood, etc., for example, and also as a protective colloid for stabilizing and increasing the setting rate of dispersion-based adhesives.

Polyvinyl ethers are used preferably as base polymers for adhesives. Among the polyvinyl ethers, the following three polymers in particular are of interest as base materials for adhesives: polyvinyl methyl ethers, polyvinyl ethyl ethers, polyvinyl isobutyl ethers

The polyvinyl ethers at moderate degrees of polymerization are tacky plasticizing resins possessed of very good adhesion properties to porous and smooth surfaces. Polyvinyl methyl ether is notable in particular for the fact that, owing to its water-solubility, it can be moistened again and therefore, for example, as a mixture with dextrin or animal glues, used as a gum on label papers, endows them with improved adhesion. On account of their permanent tackiness, polyvinyl ethers are also employed in pressure-sensitive adhesives.

Ethylene-vinyl acetates, a copolymer of ethylene and vinyl acetate, are used preferably as base polymers for adhesives. In the molecular structure the vinyl acetate molecules are incorporated randomly in the ethylene chain. While the elimination of acetic acid makes the polyvinyl acetate relatively unstable under temperature load, the copolymers with ethylene are significantly more resistant in terms of oxidation and thermal degradation. For this reason, EVA copolymers with an approximately 40% vinyl acetate fraction are among an important group of base hotmelt adhesive materials.

Ethylene-acrylic acid copolymers are used preferably as base polymers for adhesives. They are copolymers of ethylene and of acrylic acid and/or acrylic esters.

These copolymers, which combine the chemical resistance of polyethylene with the good properties of the acid and/or ester moiety, represent important base polymers for hotmelt adhesives. The ester component used is preferably ethyl acrylate.

Polyvinylacetals are used preferably as base polymers for adhesives. Polyvinylacetals come about through the action of aldehydes on alcohols. The most important acetals for adhesives manufacture are polyvinylformal and polyvinylbutyral. Both serve as a plasticizing component for phenolic resin-based adhesives. Polyvinylbutyral, moreover, finds application as an adhesive film in laminated safety glass.

Polystyrenes are used preferably as base polymers for adhesives. The monomer is in use as a constituent for adhesive base materials predominantly in two areas:
as a copolymer with plasticizing monomers, particularly butadiene, for the preparation of styrene-butadiene dispersions; and as a “polymerizable” solvent for copolymerization with unsaturated polyesters.

Polyvinyl chloride is used preferably as base polymer for adhesives. It is used more particularly for plastisol adhesives, and also as a copolymer with vinyl acetate to give vinyl chloride/vinyl acetate copolymers in solvent-based adhesives, dispersion-based adhesives, heat-sealing adhesives, and as a high-frequency welding assistant.

Styrene-butadiene rubber is used preferably as base polymer for adhesives. Styrene-butadiene rubber is a typical example of a thermoplastic elastomer, combining the application properties of elastomers with those of thermoplastics. The styrene-butadiene copolymer (SBS) and the styrene-isoprene copolymer (SIS) are what are called triblock copolymers, constructed linearly of successive identical monomer units in individual blocks. The end blocks are polystyrene segments, while the middle block is polybutadiene (styrene-butadiene-styrene block copolymer, SBS) or else isoprene (styrene-isoprene-styrene block polymer, SIS).

The ratio of styrene fraction to butadiene fraction or of styrene fraction to isoprene fraction is approximately 1:3. Unlike adhesive layer polymers which owe their elastic properties to the addition of plasticizer, in this way an “internal plasticizing” is achieved. A particular advantage of these rubber copolymers is their ability to form adhesive layers having good adhesion properties and high flexibility. Significant application therefore exists in situations where the adhesively bonded adherends are subject in practical use to high deformation stresses, such as in footwear or with rubber/rubber or rubber/metal bonds, for example.

Chloroprene rubber (CR) is used preferably as base polymer for adhesives. Chloroprene rubber (polychloroprene) comes about as a polymerization product and copolymerization product of chloroprene (2-chloro-butadiene). Besides the good adhesion properties, the linear macromolecules possess a strong propensity towards crystallization, which contributes to a relatively high strength on the part of the adhesive layer. These polymers and copolymers are important base materials for contact adhesives. The double bond present within the polychloroprene molecule allows additional crosslinking to be carried out with correspondingly reactive molecule groups. Thermosetting components used for this purpose include isocyanates and phenolic resins.

Nitrile rubber (NBR) is used preferably as base polymer for adhesives. Nitrile rubber is a copolymer of butadiene with a fraction of approximately 20% to 40% of acrylonitrile. The high acrylonitrile fraction endows these polymers with effective plasticizer resistance, so making them highly suitable, for example, for the bonding of plasticized plastics.

Butyl rubber is used preferably as base polymer for adhesives. Butyl rubber is a copolymer composed of a predominant fraction of isobutylene with isoprene. Within this linear chain molecule there exist, in the form of the long polyisobutylene segments, very high chain fractions of saturated character, at which no further crosslinking is possible. The sole crosslinkable component is the isoprene molecule, and so the overall properties of the butyl rubber are determined by the fraction of the number of double bonds, predetermined by the isoprene. The reactivity can be further influenced by incorporation of monomers containing chlorine or bromine.

Polysulphides are used preferably as base polymers for adhesives. Raw materials for polysulphide sealants have long been known under the trade name Thiokol®. Polysulphide polymers are obtained by reacting dichloroethylformal with sodium polysulphide. The molecular weight of the liquid polymers is between 3000 and 4000. By reaction with an oxidizing agent, manganese dioxide for example, they can be converted into an ultimate rubber-elastic state.

Polyethylenes are used preferably as base polymers for adhesives. The low molecular mass types, with melt indices in the range from 2 to 2000 g/10 min, have found use, in combination with tackifying resins and microwaxes, as hotmelt adhesives in the paper and cardboard industry.

Polypropylenes are used preferably as base polymers for adhesives. Polypropylene is in use as a base material for hotmelt adhesives with moderate strength properties, more specifically in the form of atactic polypropylene.

Fluorinated hydrocarbons are used preferably as base polymers for adhesives. Polyfluoro-ethylene-propylene is a copolymer of tetrafluoroethylene and hexafluoro-propylene and has been studied as a base material for hotmelt adhesives. The advantage of these products lies in the high long-term temperature durability.

Polyamides are used preferably as base polymers for adhesives. The polyamides represent some of the most important base materials for the physically setting hotmelt adhesives. Suitable for the preparation of the polyamides are the reactions described below, which typically take place in the melt under a nitrogen atmosphere: polycondensation of diamines with dicarboxylic acids; polycondensation of aminocarboxylic acids; polycondensation from lactams; polycondensation of diamines with dimerized fatty acids.

Saturated polyesters and copolyesters are used preferably as base polymers for adhesives. Saturated polyesters and copolyesters come about through polycondensation from dicarboxylic acids and diols. They are an important base material for hotmelt adhesives.

Phenol-formaldehyde resins are used preferably as base polymers for adhesives. These polymers come about through a polycondensation reaction between phenol and formaldehyde, forming highly crosslinked phenolic resins which are used as a base material for adhesives for—for example—aircraft construction. Pure phenol-formaldehyde resins are generally too brittle. For this reason they are modified with thermoplastic polymers by copolymerization or cocondensation, for example with polyvinylformal, polyvinylbutyral, polyamides, epoxy resins or elastomers, for example polychloroprene and nitrile rubber.

Cresol-/resorcinol-formaldehyde resins are used preferably as base polymers for adhesives. Besides phenol as a starting monomer for formaldehyde condensations, use is also made of phenol derivatives, such as cresols and resorcinol, as co-reactants.

Urea-formaldehyde resins are used preferably as base polymers for adhesives. A large number of nitrogen-containing organic compounds are capable of polycondensation with aldehydes. For application as adhesives, urea and melamine in particular have acquired importance. With the urea-formaldehyde resins the reaction sequence takes place initially in the form of an addition reaction in weakly acidic solution. The actual polycondensation reaction, leading to the formation of the polymeric adhesive layer, results in highly crosslinked polymers via the formation either of an ether bridge or of a methylene bridge.

Melamine-formaldehyde resins are used preferably as base polymers for adhesives. Like urea, melamine as well reacts with formaldehyde to form methylol compounds. As in the case of the urea reactions, the polycondensation with these compounds too proceeds via methylene or methylene ether linkages to form high molecular mass, highly crosslinked, hard and in some cases brittle adhesive layers.

Polyimides are used preferably as base polymers for adhesives. The experiments on the use of the polyimides arise out of the concern to have organically based adhesives available for high temperature challenges. The preparation of technically utilizable polyimides is accomplished by reaction of the anhydrides of tetrabasic acids, for example pyromellitic anhydride, with aromatic diamines, for example diaminodiphenyl oxide. Use as an adhesive is accomplished starting from a precondensate, in the form of solutions or films.

Polybenzimidazoles are used preferably as base polymers for adhesives.

The polybenzimidazoles are likewise to be classed as adhesives of high heat resistance. They come about through a polycondensation reaction from aromatic tetramines with dicarboxylic acid.

Polysulphones are used preferably as base polymers for adhesives. The polysulphones likewise belong to the group of heat-resistant adhesives. They are obtained, for example, through a polycondensation reaction from dihydroxydiphenyl sulphone with bisphenol A.

The alkyl silane component of the liquid adhesive compositions of the present invention is selected from:
the alkyl silane is selected from:
   monomeric alkyl silanes of formula I:

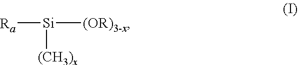

with
Rₐ=linear, branched or cyclic alkyl group with 1 to 18 carbon atoms,
x=0-2,
R=H₃C—(CH₂)_{y} with y=0-2;
or
linear oligomeric alkyl silanes of formula II:

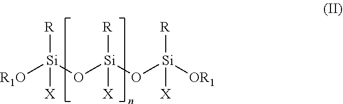

with
R=linear, branched or cyclic alkyl group with 1 to 18 carbon atoms,
R₁=H₃C—(CH₂)_{y} with y=0-2,
X=H₃C— or H₃C—(CH₂)_{y}O— with y=0-2,
n=0-20;
or
branched oligomeric alkyl silanes of formula III:

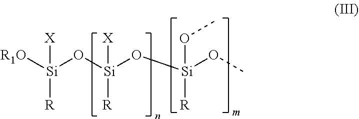

with
R=linear, branched or cyclic alkyl group with 1 to 18 carbon atoms,
R₁=H₃C—(CH₂)_{y} with y=0-2,
X=H₃C— or H₃C—(CH₂)_{y}O— with y=0-2,
n=0-20,
m=0-20;
or
cyclic oligomeric alkyl silanes of formula IV:

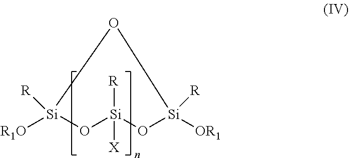

with
R=linear, branched or cyclic alkyl group with 1 to 18 carbon atoms,
R₁=H₃C—(CH₂)_{y} with y=0-2,
X=H₃C— or H₃C—(CH₂)_{y}O— with y=0-2,
n=0-20;
or mixtures of monomeric alkyl silanes of formula I and oligomeric linear, branched and/or cyclic alkyl silanes of formulae II, III and/or IV.

In a preferred embodiment the at least one alkyl silane in the liquid adhesive composition according to the present invention is selected from:
monomeric alkyl silanes of formula I:

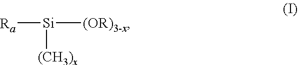

with
Rₐ=linear, branched or cyclic alkyl group with 1 to 18 carbon atoms,
x=0-2,
R=H₃C—(CH₂)_{y} with y=0-2;
or
linear oligomeric alkyl silanes of formula II:

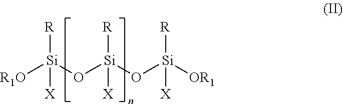

with
R=linear, branched or cyclic alkyl group with 1 to 18 carbon atoms,
R₁=H₃C—(CH₂)_{y} with y=0-2,
X=H₃C— or H₃C—(CH₂)_{y}O— with y=0-2,
n=0-20;
or mixtures of monomeric alkyl silanes of formula I and oligomeric linear alkyl silanes of formula II.

In another preferred embodiment the at least one alkyl silane in the liquid adhesive composition according to the present invention is selected from:
Propyltrimethoxysilane, Propyltriethoxysilane, Isobutyltrimethoxysilane, Isobutyltriethoxysilane, Hexyltrimethoxysilan, Hexyltriethoxysilan, Octyltrimethoxysilane, Octyltriethoxysilane, Hexadecyltrimethoxysilane, Hexadecyltriethoxysilane, Oligomeric alkoxysilanes (e.g. Dynasylan® SIVO 502 (oligomeric alkylsilane, ethoxybased)), or mixtures thereof.

In another preferred embodiment the at least one alkyl silane in the liquid adhesive composition according to the present invention is an Oligomeric alkoxysilane (e.g. Dynasylan® SIVO 502), hexadecyltrimethoxysilane, or mixtures thereof.

In a particularly preferred embodiment the at least one alkyl silane in the liquid adhesive composition according to the present invention is hexadecyltrimethoxysilane.

The rheological effects obtained from combining hydrophobized fumed silica and alkyl silane according to the present invention can be generated with a broad range of silica/silane-mass ratios. In a preferred embodiment of the present invention the total mass of the at least one alkyl silane according to the present invention is in the range between 5 and 60 wt % of the total mass of the hydrophobized fumed silica according to the present invention contained in the liquid adhesive composition. In a particularly preferred embodiment of the present invention the total mass of the at least one alkyl silane according to the present invention is in the range between 20 and 40 wt % of the total mass of the hydrophobized fumed silica according to the present invention contained in the liquid adhesive composition.

In another aspect, the present invention, further, relates to a process for the manufacture of a liquid adhesive composition, comprising at least one base polymer, at least one hydrophobized fumed silica, and at least one alkyl silane according to the invention, comprising the step:
admixing at least one base polymer, at least one hydrophobized fumed silica, at least one alkyl silane and, optionally, other components of the liquid adhesive composition according to the invention.

In another aspect, the present invention, further, relates to liquid adhesive compositions, obtainable by a such processes.

The adhesives of the present invention are typically used in the following applications: Automotive, construction, windmill bonding pastes, chemical ankers, insulation glass units, structural wood components.

The following examples are intended to elucidate the invention in greater detail.

### EXPERIMENTS

The following procedure was performed for each of the compositions listed in tables 1 to 3.

First, epoxy resin and silane were mixed with a Speed Mixer DAC 150 FVZ for 2 minutes at 2500 upm (94 weight parts epoxy resin Epikote® Resin 828 and silane (amount of silane indicated in tables 1 to 3, unless silane is not included in the particular composition).

Afterwards silica (6 weight parts or 5 weight parts-cf. tables 1 to 3) was added and the resulting composition was first mixed for 1 minute at 3000 upm and after adding material scraped off of upper parts of the container, it was mixed again for 2 minutes at 3000 upm.

The resulting mixture was first cooled down to 22° C. within 90 minutes. Afterwards the viscosity of the mixture at different shear rates was measured with a rheometer at 22° C. (Physica MCR 301, Physica MCR 302). Subsequently, the samples were stored at 22° C. for the duration indicated in tables 1 to 3 (“time”) and measurement of viscosity repeated thereafter.

As indicated by the data in tables 1 to 3, addition of the oligomeric alkylsilane increases the viscosity of the compositions at lower shear rates leading to the conclusion that the thixotropy of such compositions can be increased very effectively with hydrophobized silica if alkylsilanes are added to the composition as well. Importantly, as this was unknown in the prior art, this effect can be achieved with hydrophobized silica exhibiting a low carbon content (AEROSIL® R 974 exhibits a carbon content in the range between 0.9 and 1.5 wt %), AEROSIL® R 106 exhibits a carbon content in the range between 1.4 and 3.0 wt %).

Specifically, this is evidenced very clearly by the data regarding compositions of AEROSIL® R 974 and AEROSIL® R 106: While compositions comprising AEROSIL® R 974 and AEROSIL® R 106 without alkylsilanes exhibit very low viscosities at a shear rate of 0.1 s-1 (cf. tables 1 and 3), viscosity at a shear rate of 0.1 s-1 dramatically increases after addition of the alkylsilanes.

High carbon content hydrophobized silica, such as AEROSIL® R 202 (AEROSIL® R 202 exhibits a carbon content in the range between 3.51 and 5.0 wt %) are often used to achieve thixotropy levels and anti sagging properties (indicated by a high viscosity at lower shear rates) in adhesives and sealants formulations. However, such high carbon content hydrophobized silica are comparably expensive and available only in limited amounts. Accordingly, it is important to note, that combining low carbon content hydrophobized silica like AEROSIL® R 106 with a mixture of alkylsilanes such as Dynasylan® SIVO 502 (an oligomeric alkyl silane) yields epoxy resin-compositions with similar viscosities at low shear rates as epoxy resin-compositions of high carbon content hydrophobized silica, such as AEROSIL® R 202 (cf. table 1).

A slight increase of viscosity at lower shear rates, resulting from the addition of alkylsilanes, can also be observed for high carbon content hydrophobized silica, such as AEROSIL® R 202 in epoxy mixtures (cf. table 2)

TABLE 1
Viscosities (in Pa*s) at different shear rates, of mixtures containing
6 weight parts of the respective AEROSIL ® type, 94 weight
parts of Epikote Resin 828, and X weight parts of Dynasylan ® SIVO 502

| | AEROSIL ® | | AEROSIL ® | | AEROSIL ® | | AEROSIL ® | | AEROSIL ® | |
|---|---|---|---|---|---|---|---|---|---|---|
| | R 202 | | R 106 | | R 106 | | R 974 | | R 974 | |
| | X = 0 | | X = 0 | | X = 2 | | X = 0 | | X = 2 | |
| | Shear rate | | | | | | | | | |
| time | 0.1 s−1 | 100 s−1 | 0.1 s−1 | 100 s−1 | 0.1 s−1 | 100 s−1 | 0.1 s−1 | 100 s−1 | 0.1 s−1 | 100 s−1 |
| 90 min | 2600 | 47 | 90 | 58 | 2700 | 40 | 63 | 63 | 2300 | 44 |
| 1 d | 2500 | 46 | 80 | 57 | 2600 | 40 | 61 | 61 | 2100 | 44 |
| 7 d | 2500 | 48 | 71 | 55 | 2400 | 41 | 63 | 64 | 2000 | 44 |
| 28 d | 2300 | 46 | 66 | 55 | 2200 | 41 | 63 | 63 | 1800 | 38 |

TABLE 2
Viscosities (in Pa*s) at different shear rates, of
mixtures containing 6 weight parts of the respective
AEROSIL ® type, 94 weight parts of Epikote
Resin 828, and X weight parts of Dynasylan ® SIVO 502

| | AEROSIL ® R 202 | AEROSIL ® R 202 |
|---|---|---|
| Shear rate | X = 0 | X = 2 |

| | | | | |
|---|---|---|---|---|
| time | 0.1 s⁻¹ | 100 s⁻¹ | 0.1 s⁻¹ | 100 s⁻¹ |

| | | | | | |
|---|---|---|---|---|---|
| 90 | min | 3300 | 51 | 4300 | 40 |
| 1 | d | 3200 | 51 | 4300 | 39 |
| 7 | d | 3100 | 52 | 4300 | 40 |
| 42 | d | 2900 | 51 | 4100 | 41 |

TABLE 3
Viscosities (in Pa*s) at different shear rates, of mixtures containing
Y weight parts of the respective AEROSIL ® type, 94 weight
parts of Epikote Resin 828, and X weight parts of Dynasylan ® SIVO
502 or hexadecyltrimethoxysilane respectively

| | | | AEROSIL ® R 106, | | AEROSIL ® R 106, | |
|---|---|---|---|---|---|---|
| | AEROSIL ® R 202, | | Y = 5 | | Y = 5 | |
| | Y = 6 | | Dynasylan ® | | hexadecyltrimethoxysilane | |
| | X = 0 | | SIVO 502 X = 2 | | X = 2 | |
| | Shear rate | | | | | |
| time | 0.1 s−1 | 100 s−1 | 0.1 s−1 | 100 s−1 | 0.1 s−1 | 100 s−1 |
| 90 min | 3300 | 51 | 1500 | 31 | 790 | 29 |
| 7 d | 3100 | 51 | 1400 | 32 | 760 | 29 |

1. Liquid adhesive composition comprising:
at least one base polymer,
at least one hydrophobized fumed silica, and
at least one alkyl silane;
wherein
the base polymer is selected from:
epoxy resins, unsaturated polyester resins, polyurethane, vinyl ester resins, acrylates, polyvinyl acetate, polyvinyl alcohol, polyvinyl ethers, ethylene-vinyl acetate, ethylene-acrylic acid copolymers, polyvinyl acetates, polystyrene, polyvinyl chloride, styrene-butadiene rubber, chloroprene rubber, nitrile rubber, butyl rubber, polysulphide, polyethylene, polypropylene, fluorinated hydrocarbons, polyamides, saturated polyesters and copolyesters, phenol-formaldehyde resins, cresol-/resorcinol-formaldehyde resins, urea-formaldehyde resins, melamine-formaldehyde resins, polyimides, polybenzimidazoles, polysulphones or mixtures thereof;
and wherein
the hydrophobized fumed silica exhibits a carbon content in the range between 0.4 and 3.5 wt %;
and wherein
the alkyl silane is selected from:
monomeric alkyl silanes of formula I: 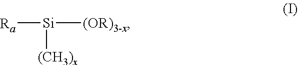
with
Rₐ=linear, branched or cyclic alkyl group with 1 to 18 carbon atoms,
x=0-2,
R=H₃C—(CH₂)_{y} with y=0-2;
or
linear oligomeric alkyl silanes of formula II: 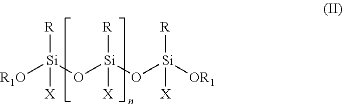
with
R=linear, branched or cyclic alkyl group with 1 to 18 carbon atoms,
R₁=H₃C—(CH₂)_{y} with y=0-2,
X=H₃C— or H₃C—(CH₂)_{y}O— with y=0-2,
n=0-20;
or
branched oligomeric alkyl silanes of formula III: 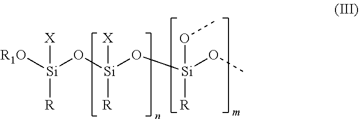
with
R=linear, branched or cyclic alkyl group with 1 to 18 carbon atoms,
R₁=H₃C—(CH₂)_{y} with y=0-2,
X=H₃C— or H₃C—(CH₂)_{y}O— with y=0-2,
n=0-20,
m=0-20;
or
cyclic oligomeric alkyl silanes of formula IV: 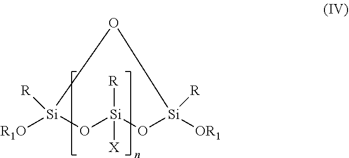
with
R=linear, branched or cyclic alkyl group with 1 to 18 carbon atoms,
R₁=H₃C—(CH₂)_{y} with y=0-2,
X=H₃C— or H₃C—(CH₂)_{y}O— with y=0-2,
n=0-20;
or mixtures of monomeric alkyl silanes of formula I and oligomeric linear, branched and/or cyclic alkyl silanes of formulae II, III and/or IV.

2. Liquid adhesive composition according to claim 1, wherein the at least one alkyl silane is selected from:
monomeric alkyl silanes of formula I: 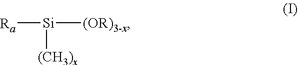
with
Rₐ=linear, branched or cyclic alkyl group with 1 to 18 carbon atoms,
x=0-2,
R=H₃C—(CH₂)_{y} with y=0-2;
or
linear oligomeric alkyl silanes of formula II: 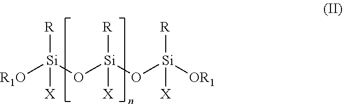
with
R=linear, branched or cyclic alkyl group with 1 to 18 carbon atoms,
R₁=H₃C—(CH₂)_{y} with y=0-2,
X=H₃C— or H₃C—(CH₂)_{y}O— with y=0-2,
n=0-20;
or mixtures of monomeric alkyl silanes of formula I and oligomeric linear alkyl silanes of formula II.

3. Liquid adhesive composition according to claim 1, wherein the at least one alkyl silane is selected from: Propyltrimethoxysilane, Propyltriethoxysilane, Isobutyltrimethoxysilane, Isobutyltriethoxysilane, Hexyltrimethoxysilan, Hexyltriethoxysilan, Octyltrimethoxysilane, Octyltriethoxysilane, Hexadecyltrimethoxysilane, Hexadecyltriethoxysilane, Oligomeric alkoxysilanes (e.g. Dynasylan® SIVO 502), or mixtures thereof.

4. Liquid adhesive composition according to claim 1, wherein the at least one hydrophobized fumed silica exhibits a carbon content in the range between 0.4 and 3.0 wt %.

5. Liquid adhesive composition according to claim 1, wherein the at least one hydrophobized fumed silica exhibits a carbon content in the range between 0.4 and 2.0 wt %.

6. Liquid adhesive composition according to claim 1, wherein the total mass of the at least one hydrophobized fumed silica is in the range between 1 and 30 wt % of the total mass of the liquid adhesive composition.

7. Liquid adhesive composition according to claim 1, wherein the total mass of the at least one hydrophobized fumed silica is in the range between 2 and 10 wt % of the total mass of the liquid adhesive composition.

8. Liquid adhesive composition according to claim 1, wherein the total mass of the at least one alkyl silane is in the range between 5 and 60 wt % of the total mass of the at least one hydrophobized fumed silica contained in the liquid adhesive composition.

9. Liquid adhesive composition according to claim 1, wherein the total mass of the at least one alkyl silane is in the range between 20 and 40 wt % of the total mass of the at least one hydrophobized fumed silica contained in the liquid adhesive composition.

10. Liquid adhesive composition according to claim 1, wherein the at least one base polymer is an epoxy resin.

11. Process for the manufacture of a liquid adhesive composition according to claim 1, comprising at least one base polymer, at least one hydrophobized fumed silica, and at least one alkyl silane, comprising the step:
admixing the at least one base polymer, at least one hydrophobized fumed silica, at least one alkyl silane and, optionally, other components of the liquid adhesive composition.

12. Liquid adhesive composition, obtainable by a process according to claim 11.
